(19) United States
(12) Patent Application Publication
(10) Pub. No.: US 2023/0011453 A1
(43) Pub. Date: Jan. 12, 2023

(54) Artificial Reality Teleportation Via Hand Gestures

(71) Applicant: Meta Platforms Technologies, LLC, Menlo Park, CA (US)

(72) Inventor: Etienne PINCHON, London (GB)

(21) Appl. No.: 17/369,112

(22) Filed: Jul. 7, 2021

(51) Int. Cl. G06F 3/01

(52) U.S. Cl. CPC G06F 3/017; G06F 3/011

(57) ABSTRACT

Aspects of the present disclosure are directed to a teleportation system for artificial reality. The teleportation system can recognize a user making a first gesture (e.g., palm-facing-down fist with thumb out) and in response, can set a first origin point at the location of the first gesture. As the user holds the hand pose of the first gestures and moves it relative to the first origin point, a potential destination point is set according to the distance and direction between the hand pose of the first gestures and the first origin point. Thus, the angle and distance of the user's hand from the first origin point can control the direction and distance of a potential teleport destination. In some cases, the first gesture can include a user's fingers curled into a fist with the thumb tip away from the fingers.

### TECHNICAL FIELD

The present disclosure is directed to methods and systems for teleportation in artificial reality (XR) in response to a gear-shift user hand gestures.

### BACKGROUND

A variety of systems can provide artificial reality (XR) environments, such as by projectors, head mounted displays, “cave” systems, etc. Users can interact with an artificial reality environment such as by selecting objects, moving, rotating, resizing, actuating controls, changing colors or skins, defining interactions between virtual objects, setting virtual forces to act on virtual objects, or practically any other imaginable action. Various interaction modalities exist for these taking such actions in an XR environment. In some cases, a user operating in an XR environment can navigate between locations using commands. For example, some systems can employ one or more of gaze controls, hand-held hardware devices, gesture controls, wearable devices (e.g., wrist bands), voice controls, etc.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which can be used in some implementations of the present technology.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for executing on a teleportation command in an artificial reality environment.

FIG. 6A is an illustration depicting a perspective view of a first teleportation hand gesture for setting an origin point for the teleportation command.

FIG. 6B is an illustration depicting a top view of an establishment of the origin point and a corresponding first operating radius for the teleportation command.

FIGS. 7A and 7C are illustrations depicting perspective views of setting a potential destination point for the teleportation command according to placement of the first teleportation gesture relative to the origin point.

FIGS. 7B and 7D are illustrations depicting top views of setting the potential destination point for the teleportation command by positioning the first teleportation gesture within the first operating radius relative to the origin point.

FIG. 8A is an illustration depicting a perspective view of a second teleportation hand gesture for setting a destination point for the teleportation command.

FIG. 8B is an illustration depicting a top view of an establishment of the destination point based on the relative positioning between the origin point and the user's hand location in the operating radius at the time of the second teleportation hand gesture.

FIG. 9A is an illustration depicting a perspective view of setting a destination orientation for the teleportation command according to placement of the second teleportation gesture and making a third teleportation gesture.

FIG. 9B is an illustration depicting a top view of setting the destination orientation for the teleportation command by positioning the second teleportation gesture within a second operating radius relative to the destination point and performing the third teleportation gesture.

FIG. 10 is a flow diagram illustrating a process used in some implementations of the present technology for teleportation to a defined location.

FIG. 11A is an illustration depicting a perspective view of setting a potential destination point for the teleportation command according to placement of the first teleportation gesture relative to the origin point and snapping to a hotspot.

FIG. 11B is an illustration depicting a top view of setting the potential destination point for the teleportation command by positioning the first teleportation gesture within the first operating radius relative to the origin point and snapping to a hotspot.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to a teleportation system for artificial reality. The teleportation system can recognize a user making a first gesture (e.g., palm-facing-down fist with thumb out) and in response, can set a first origin point at the location of the first gesture. As the user holds the hand pose of the first gestures and moves it relative to the first origin point, a potential destination point is set according to the distance and direction between the hand pose of the first gestures and the first origin point. Thus, the angle and distance of the user's hand from the first origin point can control the direction and distance of a potential teleport destination.

In some cases, there is a linear or exponential relationship between A) the distance between the user's hand holding the first gesture and the first origin point and B) the distance between the user's hand and the potential destination point. In other cases, as the destination point approaches a maximum distance threshold from the user, the system limits the distance the user can move the destination point by applying a logarithmic relationship between further movements of the user's hand and changes to the potential destination point (e.g., preventing infinite teleportation). In some cases, the potential destination point can “snap” to defined hotspots when the potential destination point is within a threshold distance of one of a defined hotspot.

When the user makes a second gesture (e.g., thumb pressed against the fist), the destination point is fixed, and a second origin point is set where the user made the second gesture. The user can then control the direction she will be facing after the teleportation (a “destination orientation”) according to the direction of her hand relative to the second origin point. In some implementations, when the selected destination point is a defined hotspot, that hotspot can have a default destination orientation that the user will be facing when she teleports there. In various implementations, the user may or may not be able to change the destination orientation for a hotspot with a default destination orientation. Upon releasing the second gesture (e.g., moving the thumb away from the fist), the user is transported to the destination point, facing the destination orientation.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Users can move in existing artificial reality environments; however, it can take the user a long time to travel between locations that are spread apart and generally requires that a user activate physical controls it signify a destination and/or movement amount. The disclosed teleportation system and methods can improve computing and/or computer system processing by teleportation based on hand gestures. The teleportation system and methods can improve computing efficiency by reducing the wireless or wired communications in the XR system by detecting the user hand gestures rather than receiving signals from controller devices, which require additional processing for localization and synchronization. Also, the present embodiments facilitate faster and more accurate movement in an artificial reality environment—allowing teleportation to specific spots with a defined orientation upon teleportation, while decreasing the travel time of the user between locations in the artificial reality environment and eliminating the need for users to interact with cumbersome controllers. Finally, the unique fist-centric gestures defined for starting a teleportation, selecting a destination point, and selecting a destination orientation improve user comfort and control as compared to both physical controllers and other hand gestures.

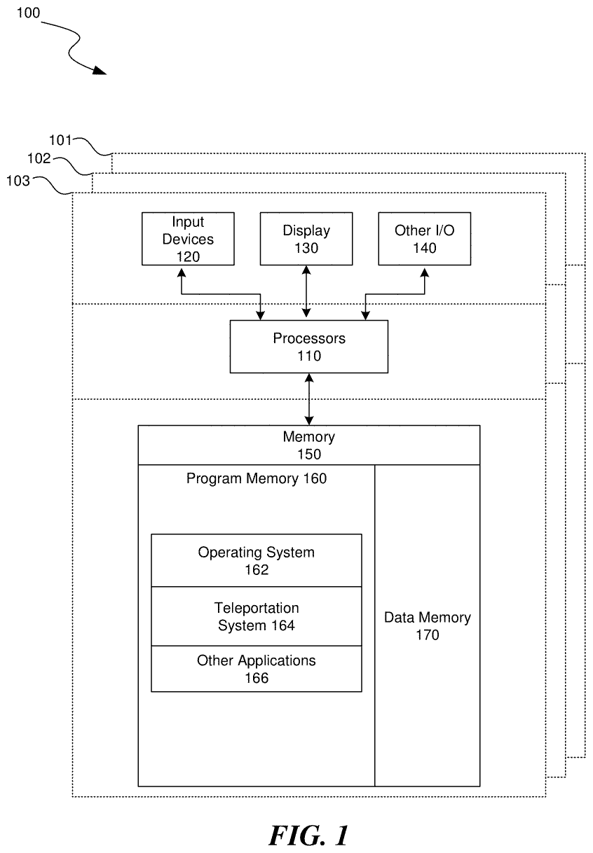

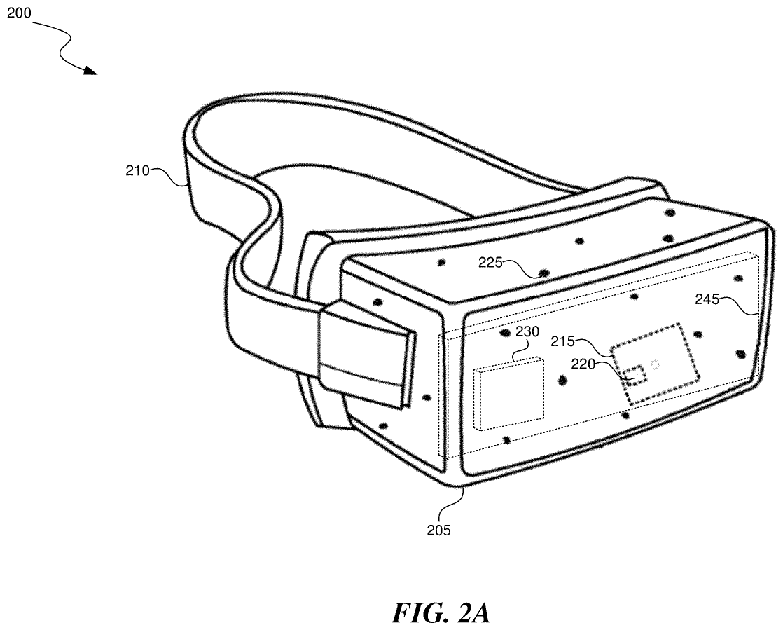

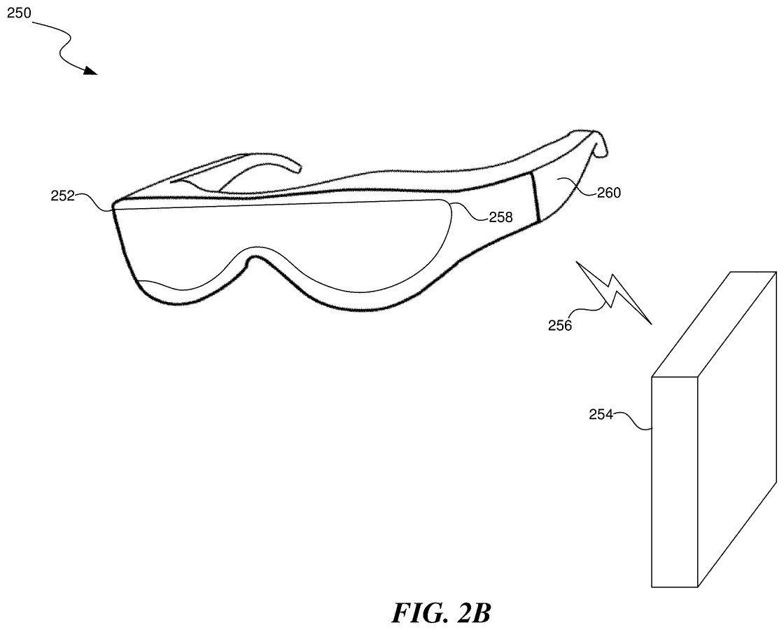

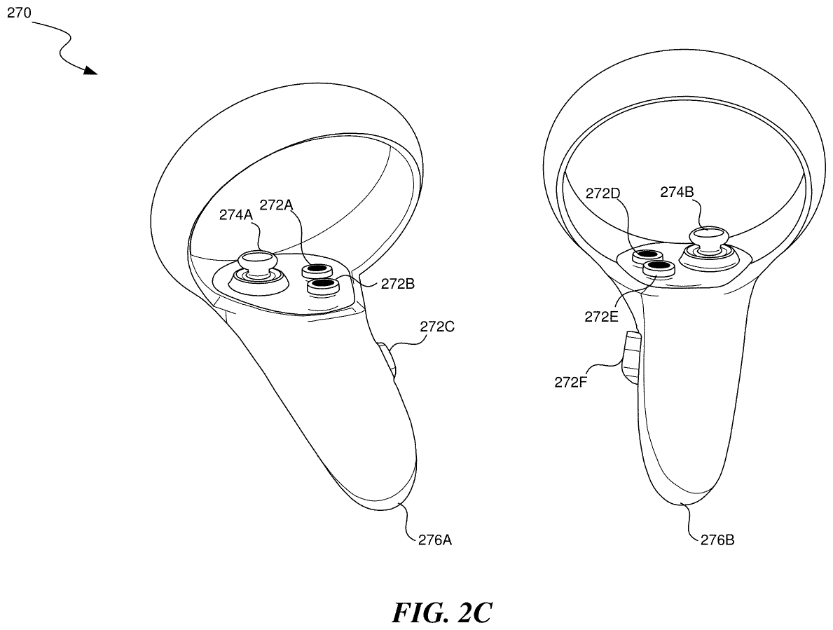

Several implementations are discussed below in more detail in reference to the figures. FIG. 1 is a block diagram illustrating an overview of devices on which some implementations of the disclosed technology can operate. The devices can comprise hardware components of a computing system 100 that is capable of executing XR teleportation commands by identifying positions of recognized hand positions and determining relative positions in an artificial reality environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, teleportation system 164, and other application programs 166. Memory 150 can also include data memory 170 that can include teleportation data, hand gesture data, orientation data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in a virtual environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270, which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc. To monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions.

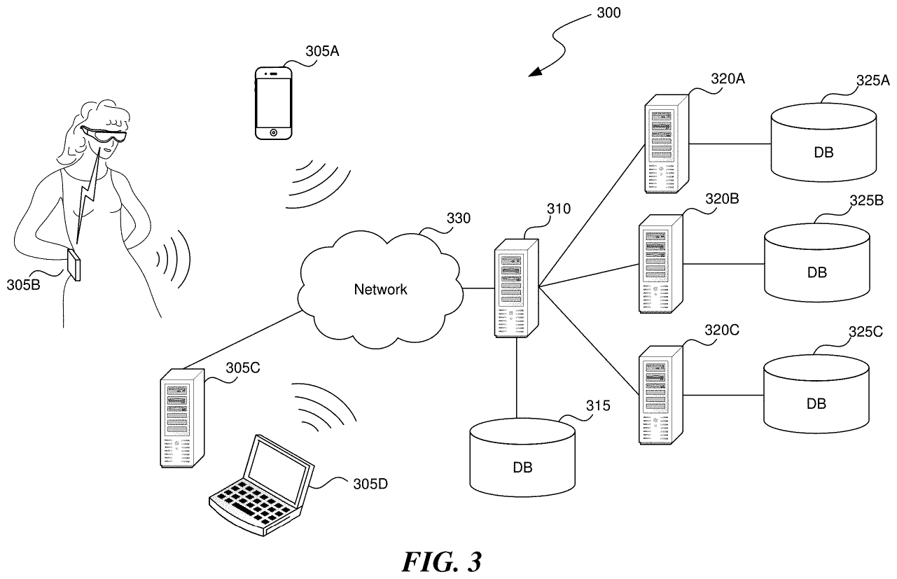

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

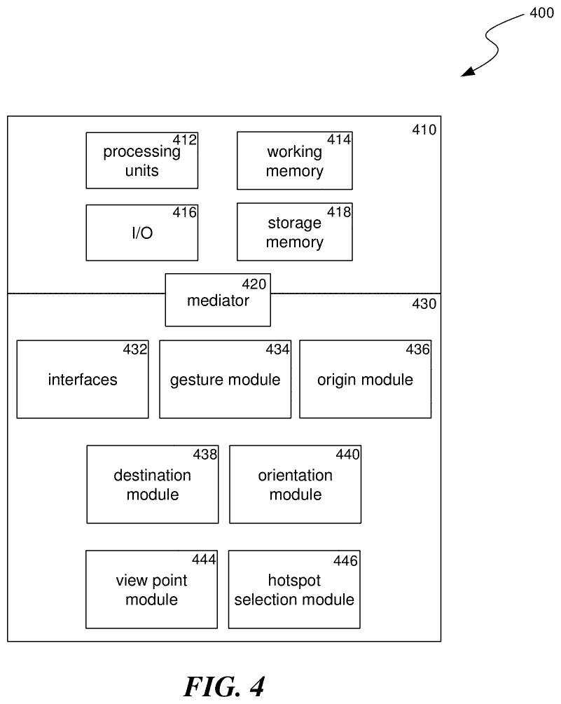

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for teleportation in an artificial reality environment via hand gestures. Specialized components 430 can include gesture module 434, origin module 436, destination module 438, orientation module 440, viewpoint module 444, hotspot selection module 446, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

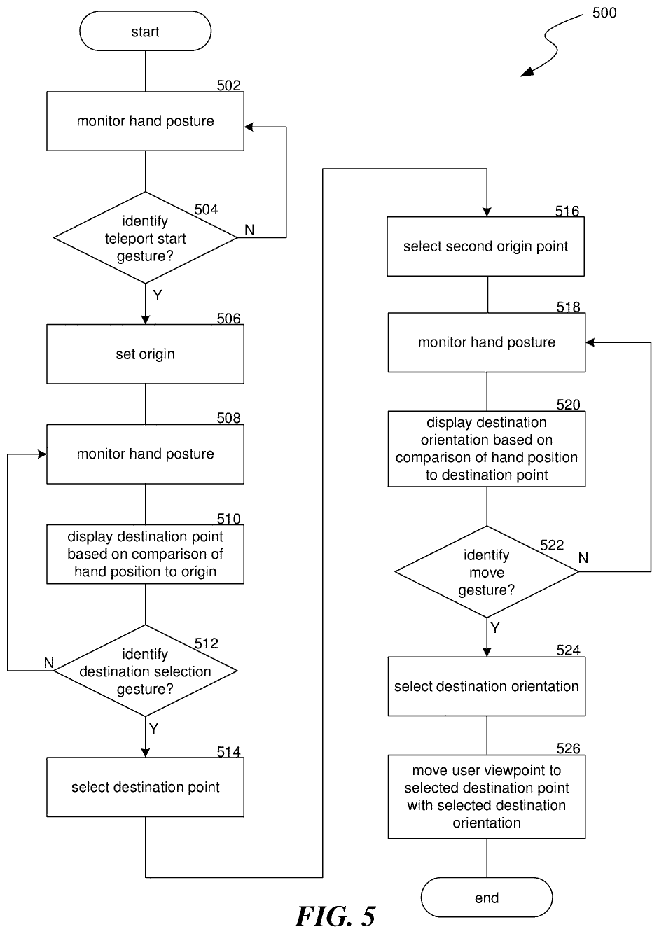

In some embodiments, the gesture module 434 can identify hand gestures of the user. The hand gestures can include teleport start gestures, destination selection gestures, movement gestures, etc. In various implementations, gesture module 434 can identify gestures using a machine learning model trained on images or other input indicating hand pose (e.g., electrical signals from a glove, bracelet, or other wearable device) to determine whether the user's hand is in a particular pose. In some implementations, the teleport gesture can include teleport a user's fingers curled into a fist with the thumb tip away from the fingers, destination selection gestures can include the user's thumb tip moving toward the fingers, and the movement gestures can include moving the thumb tip back away from the fingers. Additional details on monitoring hand postures and identifying hand gestures are provided below in relation to blocks 502, 504, 508, 512, 518, and 522 of FIG. 5.

In some embodiments, the origin module 436 can set origin points in the artificial reality environment at locations based on hand gestures of the user. The origin point can be the first location that a hand gesture is detected and is used as a reference location to compare the location of future hand movements. Additional details on setting and comparing origin points are provided below in relation to blocks 506 and 516 of FIG. 5.

In some embodiments, the destination module 438 can select a destination point in the artificial reality environment based on hand gestures of the user and distances between where a hand gesture was made and an origin point set by origin module 436. The destination points can indicate the ending location of the user after the teleportation is complete. Additional details on the destination point selection are provided below in relation to blocks 510 and 514 of FIG. 5.

In some embodiments, the orientation module 440 can determine an orientation of the user upon teleportation to the destination point identified by destination module 438. The destination orientation can be based on hand gestures of the user and directions between where a hand gesture was made and an origin point set by origin module 436. Additional details on orientation selection are provided below in relation to blocks 520 and 524 of FIG. 5.

In some embodiments, the viewpoint module 444 can set a viewpoint to the user at a destination location selected via destination module 438. The viewpoint of the user can also set an orientation upon the change to the destination, based on the destination orientation selected via orientation module 440. In a virtual reality system, changing the viewpoint and orientation can include changing where a virtual camera in a virtual reality environment is placed corresponding to the user's point of view. in an augmented reality or mixed reality system, changing the viewpoint and orientation can include changing where virtual objects are places corresponding to a different user perspective on those virtual objects. Additional details on setting a user viewpoint and orientation are provided below in relation to blocks 526 of FIG. 5.

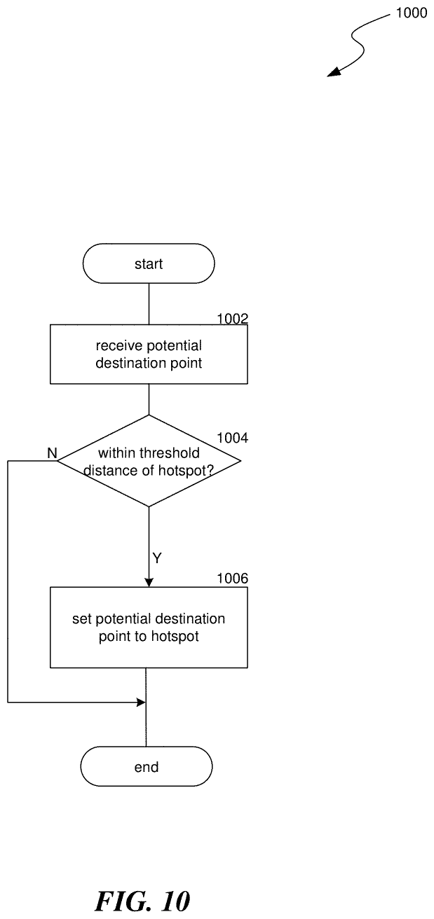

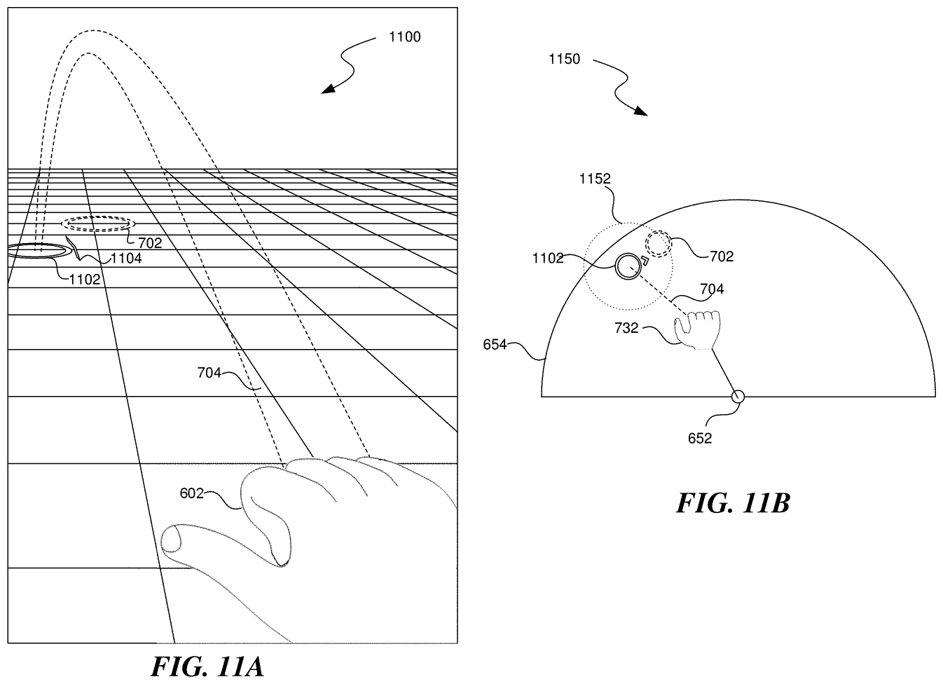

In some embodiments, the hotspot selection module 446 can be used by destination module 438 and/or orientation module 440 to snap a potential destination to a pre-defined spot (“hotspot”), which may also include setting a pre-defined destination orientation. In some cases, snapping a potential destination to a pre-defined hotspot can occur when a user moves the potential destination within a threshold distance of the pre-defined hotspot. Additional details on snapping a potential destination to a pre-defined hotspot are provided below in relation to FIGS. 10, 11A, and 11B.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations of the present technology for executing on a teleportation command in an artificial reality environment. In some cases, process 500 can be triggered by a user activating a teleportation mode, the user putting on a XR reality headset, an activation gesture by the user, a button press on a control device, or a user entering an XR environment. Process 500 can be performed locally on the XR device or performed by cloud-based device(s) that can support user teleportation.

At block 502, process 500 can monitor the hand posture of user in the artificial reality environment. Process 500 can monitor the user hand posture continuously (e.g., passing a continuous feed from a camera through a gesture recognition machine learning model) or periodically (e.g., checking for gesture in the camera feed, with the gesture recognition machine learning model periodically such as every 0.05, 0.1, 0.5, or 1 second). A hand “posture” as used herein refers to a location and/or pose of a user's hand. For example, a hand posture can comprise one or both of where the hand is in an artificial reality environment and/or the shape the hand is making. Certain hand postures can be previously identified as “gestures,” where the gesture is identified when the hand posture matches a specified gesture by a threshold amount. The processes described herein can monitor hand postures in different manners. In some cases, hand postures can be identified using input from external facing cameras that capture depictions of user hands. In other cases, hand postures can be based on input from a wearable device such as a glove or wristband that tracks aspects of the user's hands (e.g., location in 3D space and/or pose). In some implementations, input can be interpreted as postures mapped as certain gestures by applying the input to a machine learning model trained to identify hand postures and/or gestures based on such input. In some implementations, heuristics or rules can be used to analyze the input to identify hand postures and/or gestures.

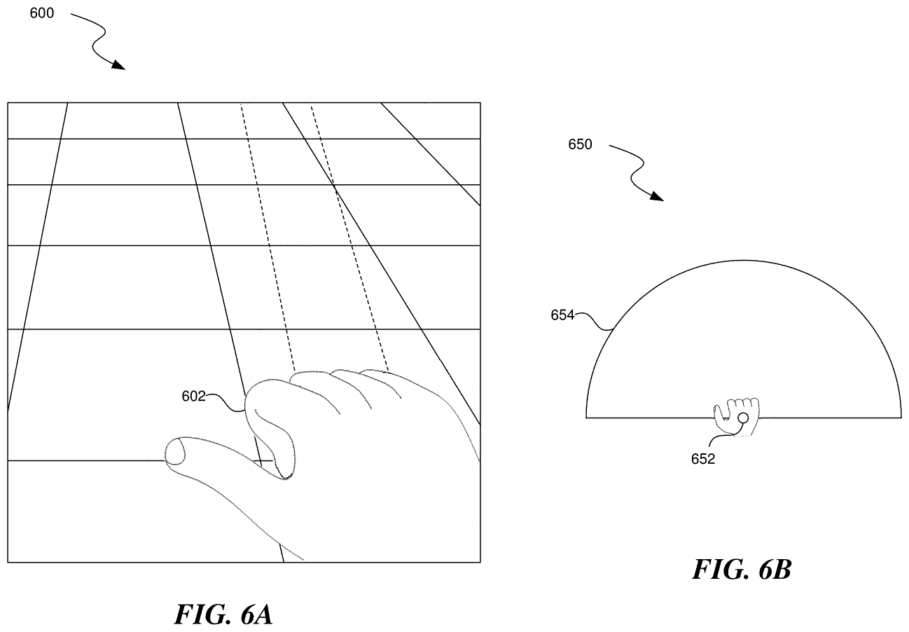

At block 504, process 500 can identify whether the user has made a teleport start gesture based on monitoring the hand posture of a user. In some cases, the teleport start gesture 602 can be four fingers curled into a fist with the thumb away from the fingers, with the palm side of the user's hand facing downward. An example of such a teleport start gesture 602 is illustrated in environment 600 of FIG. 6A. When the teleport start gesture is identified, process 500 can continue to block 506. Otherwise, when process 500 does not identify the teleport start gesture, process 500 can continue to monitor the user's hand posture by returning to block 502.

At block 506, process 500 can set a first origin point at a location that the teleport start gesture was identified. Setting the first origin point is illustrated in diagram 650 by first origin point 652 at a point where the teleport start gesture 602 is made. The first origin point can be the starting location where the teleport start gesture 602 was made and from which the user begins moving her hand. In some cases, process 500 can use the first origin point as a reference location to compare with the location of future user hand movements. An operating radius 654 is also illustrated in FIG. 6B, showing where the user can move her hand while holding the teleport start gesture to move a corresponding potential destination point. At block 508, process 500 can continue to monitor the hand posture of user in the artificial reality environment as the user holds the teleport start gesture.

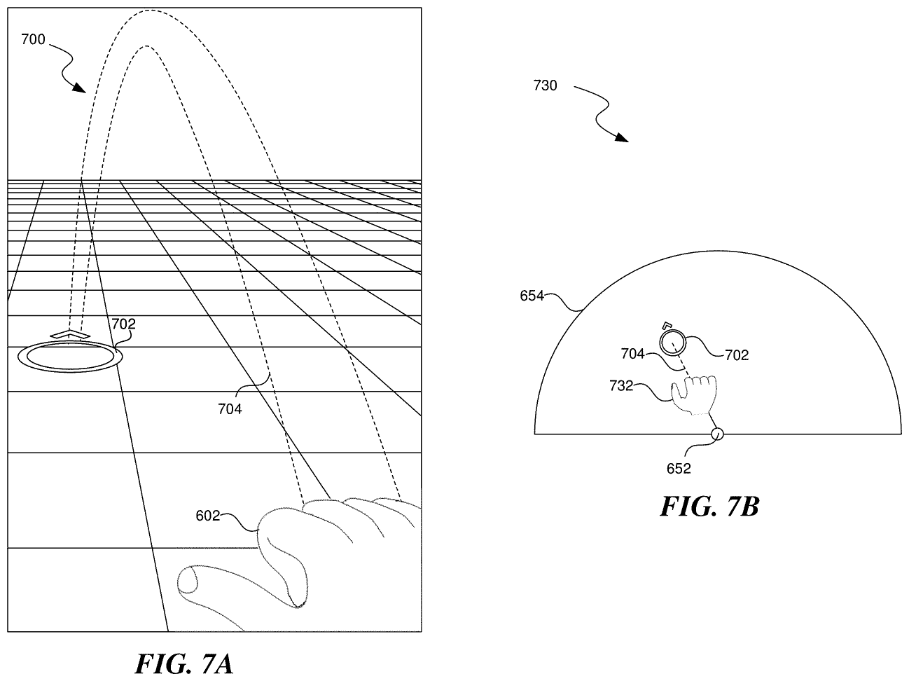

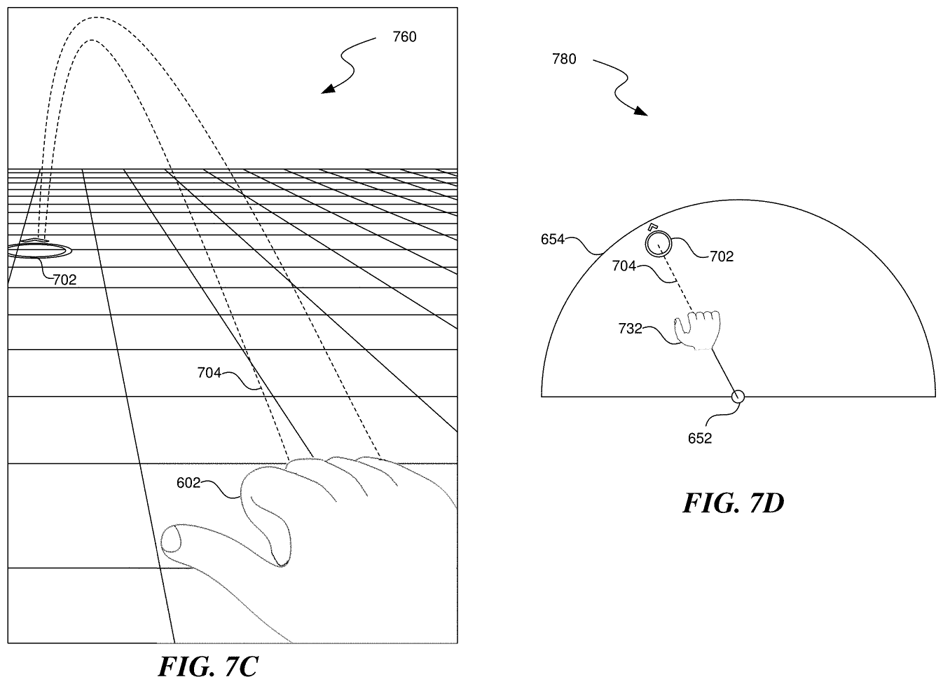

At block 510, process 500 can display a potential destination point (illustrated in environment 700 by potential destination point 702 of FIG. 7A), in the artificial reality environment. The location of the potential destination point can be based on a first comparison of A) a first hand position with B) the first origin point. FIG. 7B illustrates example 730 of the comparison of the hand position 732 to the first origin point 652 in operating radius 654. In various implementations, the potential destination point 702 has an exponential, linear, or logarithmic relationship to the distance between the first origin point 652 to the hand position 732. The potential destination point 702 can be connected to the hand position 732 by a ray 704. For example, process 500 can cast a curved, angled-downward ray out from the user's hand to the destination point. In some implementations, other types of rays can be used, such as a straight ray or an arched ray, such as arched ray 704.

In some implementations, the potential destination point can be snapped (e.g., automatically moved) to a predefined location (referred to herein as a “hotspot”) when the potential destination point is within a threshold distance of a hotspot. In such a case, process 500 can continue to monitor an indicated point where the potential destination point would be if it had not snapped to the hotspot, and if that indicated point moves outside the threshold distance from the hotspot, the potential destination point can move back to the indicated point. Additional details on snapping a potential destination point to a hotspot are discussed below in relation to FIGS. 10, 11A, and 11B.

Environment 760 of FIG. 7C and environment 780 of FIG. 7D illustrate a example where potential destination point 702 has an exponential relationship to the distance from the first origin point 652 to the hand position 732. For example, the distance between the hand position 732 and the potential destination point 702 can be exponentially larger than the distance of the hand position 732 to the first origin point 652. In another example, the relationship can be logarithmic, where additional distance between the first origin point 652 to the hand position 732 cause ever lessening changes to the distance between hand position 732 and the potential destination point 702. Such a logarithmic relationship can prevent teleportation from going too far, allowing more precise control on selecting a destination point. In yet another example, the relationship can be linear. In some cases, the relationship can change depending on the distance of the user's hand from the first origin point. For example, the relationship can be exponential in a range nearest the first origin point, linear in an intermediate range, and logarithmic in a range beyond the intermediate range.

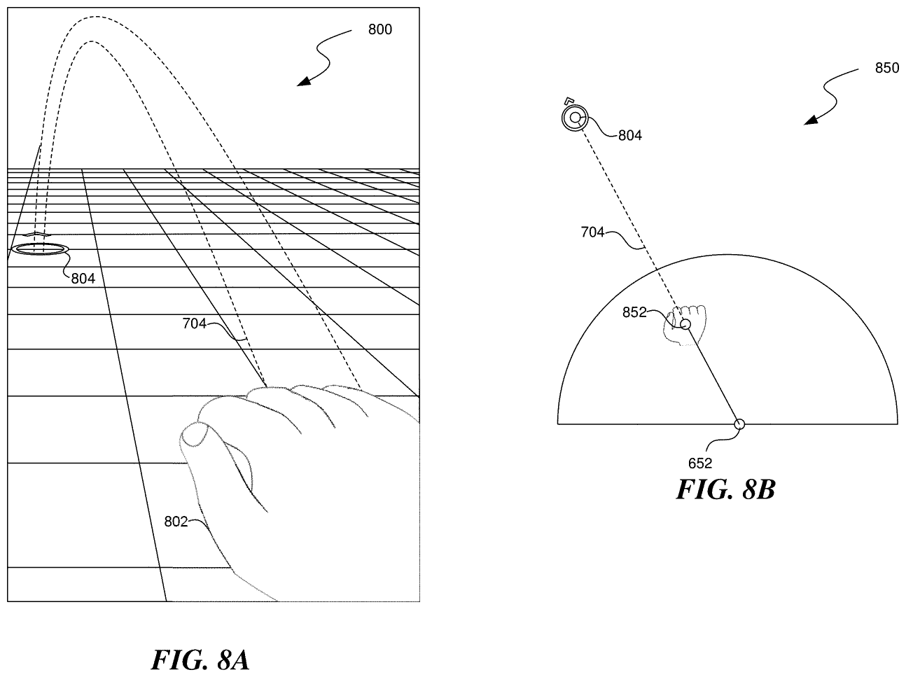

At block 512, process 500 can identify a destination selection gesture based on monitoring the hand posture of the user (from block 508). For example, the destination selection gesture can include the user brining her thumb in to press against her index finger while maintaining her four fingers curled into a fist (e.g., gesture 802 of FIG. 8A). When the destination selection gesture is identified, process 500 can continue to block 514. Otherwise, when process 500 does not identify the destination selection gesture, process 500 can continue to monitor the user's hand posture by returning to block 508.

At block 514, process 500 can select the destination point based on the position of the displayed potential destination point when the destination selection gesture was made. FIG. 8A illustrates an example of a destination selection gesture 802 to select the destination point 804 in environment 800 based on a current potential destination point 702.

At block 516, process 500 can set a second origin point at the position where the user performed the destination selection gesture. The second origin point can be a new starting location from which the user begins moving her hand to indicate a destination orientation (i.e., a direction the user will be facing following the teleportation). Thus, process 500 can use the second origin point as a reference location to compare the location of the user hand movements around the second origin point to determine orientation at the destination point. FIG. 8B illustrates an example 850 of setting the second origin point 852 and destination point 804 in response to the destination selection gesture 802.

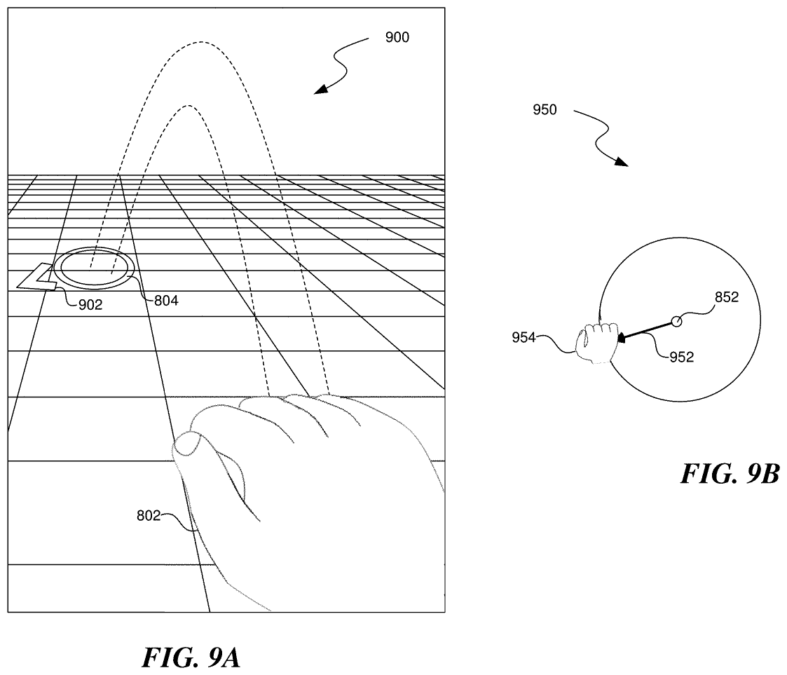

At block 518, process 500 can monitor the hand posture of user in the artificial reality environment. At block 520, process 500 can determine a destination orientation based on a comparison of a second hand position (monitored at block 518) to the second origin point set at block 516. The destination orientation can indicate which direction the user will face after teleportation. FIG. 9A illustrates the destination orientation 902 of the destination point 804 in environment 900. In some cases, the user can change the destination orientation by moving her hand in relation to the second origin point. FIG. 9B illustrates the user's hand with the destination selection gesture 802 positioned at 954 in relation to the second origin point 852 (as shown by arrow 952 resulting in the comparison of the origin point 852 to the hand position 954) to determine a destination orientation 902 in environment 950 corresponding to arrow 952.

At block 522, process 500 can identify a movement gesture based on monitoring the hand posture of the user (from block 518). For example, the movement gesture can be releasing the destination selection gesture, such as by moving he user's thumb back away from the user's index finger (reforming gesture 602), opening the fist the user has been holding, or lowering the user's hand. In some cases, the hand gestures (e.g., teleport start and movement gestures, destination selection gesture, movement gestures, etc.) are performed by one hand or two hands of the user. For example, a user can perform the gestures to select the destination point with one hand and can perform the gestures to select the destination orientation with the other hand.

When the movement gesture is identified, process 500 can continue to block 524. Otherwise, when process 500 does not identify the movement gesture, process 500 can continue to monitor the user's hand posture by returning to block 518. At block 524, process 500 can select the destination orientation based on the determined destination orientation when the movement gesture was identified. At block 526, process 500 can move a viewpoint of the user to the selected destination point with the selected destination orientation.

FIG. 10 is a flow diagram illustrating a process 1000 used in some implementations of the present technology for teleportation to a defined location. In some implementations, process 1000 can be a sub-process of process 500, e.g., called at block 510. At block 1002, process 1000 can receive an indication of a potential destination point (e.g., a potential destination point set at block 510).

At block 1004, process 1000 can determine whether the indicated potential destination point is within a threshold distance of a hotspot. In some implementations, an artificial reality environment can have one or more such defined hotspots. In some cases, these hotspots can be displayed to a user with a visual indication, illustrating that moving the potential destination point near that hotspot will snap the potential destination point to the hotspot. In some cases, hotspots can be set for points of interest in the artificial reality environment. In some implementations, the threshold distance can be a set distance or a distance set differently for different hotspots (allowing the snapping behavior to be more or less sensitive for each hotspot). If the indicated potential destination point is within the threshold distance of a hotspot, process 1000 can continue to block 1006, otherwise process 1000 can end.

At block 1006, process 1000 can set the potential destination point to the hotspot. In some implementations, a hotspot can have default destination orientation pre-set for it. In various implementations, where a hotspot has a default destination orientation set, the user may or may not be able to override the default destination orientation with a user-selected destination orientation (e.g., through the execution of blocks 518-524).

As discussed above, process 500 can continue to monitor a point indicated by the user, and if it moves beyond the threshold distance from the hotspot, process 500 can move the potential destination point off the hotspot and back to the indicated point.

FIG. 11A is an illustration depicting a perspective view 1100 of setting a potential destination point for the teleportation command according to placement of the first teleportation gesture relative to the origin point and snapping to a hotspot. FIG. 11B is an illustration depicting a top view 1150 of setting the potential destination point for the teleportation command by positioning the first teleportation gesture within the first operating radius relative to the origin point and snapping to a hotspot. In 1100 a user is holding teleportation start gesture 602, causing the teleportation system to cast a ray 704 to a potential destination point 702. In this example, however, potential destination point 702 is within a threshold distance of a hotspot 1102, which has a default destination orientation 1104. Thus, the potential destination point is snapped to the hotspot 1102. In 1150, it can be seen that potential destination point 702 is within the threshold distance 1152 of the hotspot 1102, causing the potential destination point to snap to the hotspot 1102. The teleportation system continues to monitor the now indicated point 702. If indicated point 702 were to move outside the threshold distance 1152, the potential destination point would snap back to the indicated point 702. In various implementations, the indicated point 702 may or may not have a visual component displayed to a user. Upon selection of the hotspot as the destination point, the default destination orientation 1104 (which in this example cannot be overridden) is automatically selected as the destination orientation and the teleportation system moves the user to the destination point 1102 facing the direction indicated by the default destination orientation 1104.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for performing artificial reality teleportation via hand gestures, the method comprising:
identifying a teleport start gesture based on monitoring a hand posture of a user, wherein the identifying the teleport start gesture includes identifying that a user's fingers curled into a fist with the thumb tip away from the fingers;
setting a first origin point at a first location of the teleport start gesture;
displaying a potential destination point, in an artificial reality environment, based on a first comparison of A) a first hand position to B) the first origin point;
identifying a destination selection gesture comprising identifying that the user moved the thumb tip toward the fingers;
selecting, based on the destination selection gesture, the destination point according to a current position of the potential destination point; and
moving a viewpoint of the user to the selected destination point.

2. The method of claim 1 further comprising displaying, in relation the destination point, an indication of a destination orientation.

3. The method of claim 1 further comprising:
setting a second origin point at a second location corresponding to the destination selection gesture;
determining a destination orientation based on a second comparison of C) a second hand position to D) the second origin point;
identifying a movement gesture based on monitoring the hand posture of the user; and
in response to the movement gesture, selecting the destination orientation;
wherein the moving the viewpoint of the user to the selected destination point is also in response to the movement gesture, and
wherein the moving the viewpoint of the user to the selected destination point further comprises setting an orientation of the user to the selected destination orientation.

4. The method of claim 3, wherein the destination orientation rotates around the second origin point.

5. The method of claim 3, wherein the teleport start gesture, the destination selection gesture, and the movement gesture are performed by one hand of the user.

6. The method of claim 3, wherein the identifying the movement gesture comprises identifying that the user moved the thumb tip away from the fingers.

7. The method of claim 1, wherein a distance from the destination point to the first origin point has a logarithmic relationship to a distance between the first origin point and the first hand position.

8. The method of claim 1, wherein a distance from the destination point to the first hand position is displayed by a ray.

9. The method of claim 1, wherein the potential destination point is further based on identifying that an indicated point, based on the first comparison of A) the first hand position to B) the first origin point, is within a threshold distance to a defined hotspot.

10. A computer-readable storage medium storing instructions that, when executed by a computing system, cause the computing system to perform a process for performing artificial reality teleportation via hand gestures, the process comprising:
identifying a teleport start gesture based on monitoring a hand posture of a user, wherein the identifying the teleport start gesture includes identifying that a user's fingers curled into a fist with the thumb tip away from the fingers;
setting a first origin point at a first location of the teleport start gesture;
displaying a potential destination point, in an artificial reality environment, based on a first comparison of A) a first hand position to B) the first origin point;
identifying a destination selection gesture comprising identifying that the user moved the thumb tip toward the fingers;
selecting, based on the destination selection gesture, the destination point; and
moving a viewpoint of the user to the selected destination point.

11. The computer-readable storage medium of claim 10, wherein the potential destination point is further based on identifying that an indicated point, based on the first comparison of A) the first hand position to B) the first origin point, is within a threshold distance to a defined hotspot.

12. The computer-readable storage medium of claim 10, wherein the process further comprises displaying, in relation the destination point, an indication of a destination orientation.

13. The computer-readable storage medium of claim 10, wherein the process further comprises:
setting a second origin point at a second location corresponding to the destination selection gesture;
determining a destination orientation based on a second comparison of C) a second hand position to D) the second origin point;
identifying a movement gesture based on monitoring the hand posture of the user; and
in response to the movement gesture, selecting the destination orientation;
wherein the moving the viewpoint of the user to the selected destination point is also in response to the movement gesture, and
wherein the moving the viewpoint of the user to the selected destination point further comprises setting an orientation of the user to the selected destination orientation.

14. The computer-readable storage medium of claim 13, wherein the destination orientation rotates around the second origin point.

15. The computer-readable storage medium of claim 13, wherein at least two of teleport start gesture, the destination selection gesture, and/or the movement gesture are performed by different hands of the user.

16. The computer-readable storage medium of claim 13, wherein the identifying the movement gesture comprises identifying that the user moved the thumb tip away from the fingers.

17. A computing system for performing artificial reality teleportation via hand gestures, the computing system comprising:
one or more processors; and
one or more memories storing instructions that, when executed by the one or more processors, cause the computing system to perform a process comprising:
identifying a teleport start gesture based on monitoring a hand posture of a user, wherein the identifying the teleport start gesture includes identifying that a user's fingers curled into a fist with the thumb tip away from the fingers;
setting a first origin point at a first location of the teleport start gesture;
displaying a potential destination point, in an artificial reality environment, based on a first comparison of A) a first hand position to B) the first origin point;
identifying a destination selection gesture comprising identifying that the user moved the thumb tip toward the fingers;
selecting, based on the destination selection gesture, the destination point; and
moving a viewpoint of the user to the selected destination point.

18. The computing system of claim 17, wherein a distance from the destination point to the first origin point has a logarithmic relationship to a distance between the first origin point and the first hand position.

19. The computing system of claim 17, wherein the process further comprises:
setting a second origin point at a second location corresponding to the destination selection gesture;
determining a destination orientation based on a second comparison of C) a second hand position to D) the second origin point;
identifying a movement gesture based on monitoring the hand posture of the user; and
in response to the movement gesture, selecting the destination orientation;
wherein the moving the viewpoint of the user to the selected destination point is also in response to the movement gesture, and
wherein the moving the viewpoint of the user to the selected destination point further comprises setting an orientation of the user to the selected destination orientation.

20. The computing system of claim 19, wherein the identifying the movement gesture comprises identifying that the user moved the thumb tip away from the fingers.
